(19) United States
(12) Patent Application Publication
(10) Pub. No.: US 2025/0020530 A1
(43) Pub. Date: Jan. 16, 2025

(54) USE OF A GALLIUM-BASED ALLOY AS TRANSFER FLUID IN A DIAPHRAGM SEAL

(71) Applicant: Endress+Hauser SE+Co. KG, Maulburg (DE)

(72) Inventors: Dietmar Leuthner, Weil am Rhein (DE); Sergey Lopatin, Lörrach (DE)

(21) Appl. No.: 18/706,992

(22) PCT Filed: Sep. 27, 2022
(86) PCT No.: PCT/EP2022/076768

§ 371 Date: May 2, 2024

(30) Foreign Application Priority Data
Nov. 4, 2021 (DE) 10 2021 128 735.9

(51) Int. Cl. G01L 19/06; C22C 28/00; G01L 13/02

(52) U.S. Cl. CPC G01L 19/0645; C22C 28/00; G01L 13/026

(57) ABSTRACT

The present disclosure is directed to a method of using a gallium-based alloy, such as a eutectic, gallium-based alloy, as pressure transfer liquid in a hydraulic pressure transfer means for determining a process pressure in a process, in which the process medium has a process temperature ≤400° C. and a process pressure <1 bar absolute, wherein the alloy contains, besides gallium, furthermore, at least one other component and the mixing ratio between gallium and the at least one other component is selected in such a manner that the alloy has a melting temperature less than 20° C.

The invention relates to use of a gallium-based alloy, especially a eutectic, gallium-based alloy, as pressure transfer liquid in a hydraulic pressure transfer means in the form of a diaphragm seal for determining a process pressure in a process, in which the process medium has a process temperature ≤400° C. and a process pressure <1 bar absolute.

Pressure transfer means in the form of diaphragm seals with hydraulic pressure transfer have, usually, a hydraulic path, which extends between a process diaphragm and a pressure measuring cell, wherein the process diaphragm is exposed to a process medium, whose pressure is to be ascertained. Currently, such pressure transfer means essentially use an oil, especially a silicone oil, as pressure transfer liquid.

Problematic is the use of such diaphragm seals in the case of applications in processes, in which the process medium has a high temperature and a low process pressure, since under these circumstances the pressure transfer liquid outgasses or evaporates or decomposes into volatile products. Such is especially the case for so-called vacuum applications, in which the process medium has a high temperature up to about 400° C. and at the same time a low process pressure (<1 bar absolute). Such can in the most advantageous case occur reversibly according to the vapor pressure curve for the particular pressure transfer liquid, wherein, however, also in this case a plastic deformation of the process diaphragm is threatened. Plastic deformation leads to a non-reversible measurement error. Frequently, the pressure transfer liquid behaves, however, not according to the vapor pressure curve for the pure and native state, for, because of reactions with impurities or with the surfaces bounding the hydraulic path, the pressure transfer liquid can contain volatile decomposition products, which after the outgassing no longer return into solution.

It is, consequently, an object of the invention to overcome the disadvantages of the state of the art.

The object is achieved according to the invention by the use of a gallium-based alloy as pressure transfer liquid in a hydraulic pressure transfer means for determining a process pressure in a process, in which the process medium has a process temperature ≤400° C. and a process pressure <1 bar (absolute pressure), as defined in claim 1.

The use of the invention of a gallium-based alloy, especially a eutectic, gallium-based alloy, as pressure transfer liquid in a hydraulic pressure transfer means for determining a process pressure in a process, in which the process medium has a process temperature ≤400° C. and a process pressure <1 bar absolute, provides that the alloy contains, besides gallium, furthermore, at least one other component and the mixing ratio between gallium and the at least one additional component is selected in such a manner that the alloy has a melting temperature less than 20° C., especially less than 15° C.

According to the invention, use of a gallium-based alloy as pressure transfer liquid for a pressure transfer means is provided, wherein the composition of the alloy is selected in such a manner that such has a high boiling point (about 2400° C. for gallium), such that the pressure transfer means filled with the alloy can also be applied above the process conditions (process temperature <400° C. and process pressures >1 bar (absolute pressure)) usual for currently customary pressure transfer means.

An advantageous variant of the invention provides that the alloy can have a plurality of other components and the mixing ratios between gallium and the plurality of additional components are selected in such a manner that the alloy has a melting temperature less than 20° C., especially less than 15° C.

Another advantageous variant of the invention provides that the one or more other components are selected from metals having a melting point less than 450° C., preferably less than 350° C.

Another advantageous variant of the invention provides that the one or more other components are selected from indium, tin, zinc, lead, bismuth, and/or mercury.

In turn, another advantageous variant of the invention provides that the alloy contains at least 50 mass percent, preferably at least 60 mass percent, gallium.

The invention will now be explained in greater detail based on the appended drawing, the sole FIGURE of which shows as follows:

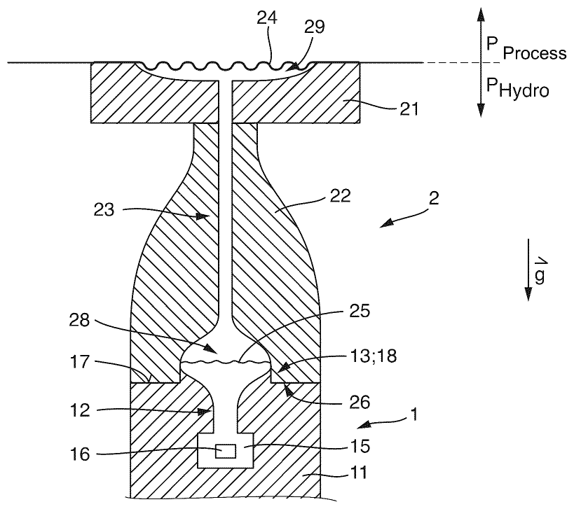

FIG. 1 a longitudinal section through a pressure transfer means formed according to the invention.

FIG. 1 shows a longitudinal section through a pressure transfer means formed according to the invention. Shown are a sensor module 1 and a transfer module 2. Sensor module 1 includes a sensor body 11, which can have an at least sectionally cylindrical symmetry or other axial symmetry. Arranged in the interior of the sensor body 11 is a measuring cell chamber 15 having, located therein, a pressure measuring cell 16 and being connected via a measuring cell duct 12 with an end face 13 of the sensor body 11. End face 13 faces toward the transfer module 2. End face 13 can, additionally, be bounded by a circularly shaped assembly wall 17, which extends in the axial direction from the end face 13. Assembly wall 17 includes a first assembly end face 18, which according to a currently preferred embodiment is planar. First assembly end face 18 is connected pressure-tightly with a matching, second assembly face.

Transfer module 2 includes, in a currently preferred embodiment, a process body 21 and a transfer body 22, each of which can have, at least sectionally, cylindrical symmetry or rotational symmetry. These symmetries are not essential for the invention. They result, however, when the components of the pressure transfer means are manufactured as turned parts.

Each of process body 21 and transfer body 22 has a traversing, axial bore between its end faces. The two bodies are pressure-tightly connected together, such that a capillary duct 23 extends between the far end faces of the process body and the transfer body.

A flexible process diaphragm 24 is secured pressure-tightly along its periphery on the sensor end face of the process body 21 facing away from the capillary duct 23. This forms between the process diaphragm 24 and the process body 21 a process pressure chamber 29, which is in communication with the capillary duct 23.

A flexible transfer diaphragm 25 is secured pressure-tightly along its periphery to the end face of the transfer body 22 facing away from the capillary duct 23. This forms between the transfer diaphragm 25 and the transfer body 22 a transfer pressure chamber 28, which is in communication with the capillary duct 23 and, as a result, with the process pressure chamber 29.

Process pressure chamber 29, capillary 23 and transfer pressure chamber 28 are filled with pressure transfer liquid and form a second hydraulic path.

In operation of the pressure transfer means of the invention, thus, the process diaphragm 24 can be exposed to a process medium, and the pressure of the medium is transferred by means of the pressure transfer liquid to the transfer diaphragm 25.

The sensor-side end face of the transfer body has the above mentioned second assembly face 26, with which the first assembly face of the sensor module is welded pressure-tightly.

The measuring cell chamber 15 as well as the volume between such and the transfer diaphragm 25, thus, the first hydraulic path, are likewise filled with the pressure transfer liquid. In this way, a pressure on the transfer diaphragm is transferred to the pressure measuring cell, so that such is supplied with a corresponding pressure for determining the pressure value. Usually, the filling occurs after the sensor body is connected with the transfer body along the first and second assembly faces. For this, there can be provided in the sensor module and in the transfer module filling ducts for filling the first and second hydraulic paths with pressure transfer liquids. Details for embodiment of the fill ducts and their closure are known to those skilled in the art and require no additional presentation.

According to the invention, used as pressure transfer liquid can be an alloy based on gallium, containing at least 50 mass percent, preferably at least 60 mass percent gallium, and also containing, besides gallium, at least one other component, with the mixing ratio between gallium and the at least one additional component being selected in such a manner that the alloy has a melting temperature less than 20° C., especially less than 15° C. Preferably, the alloy is a eutectic alloy. The one or more other components can be especially metals having a melting point of less than 450° C., such as, for example, zinc (420° C.), especially preferably metals having a melting point less than 350° C., such as, for example, indium (157° C.), tin (232° C.), lead (327° C.), bismuth (271° C.) and/or mercury (−38.8° C.), wherein it is to be noted that, while mercury is possible, it would not be used due to its toxicity.

By the use of the invention of the (eutectic) alloy, which due to its composition has a high boiling point, a pressure transfer means filled with the alloy as pressure transfer liquid can be applied also in the case of the vacuum applications mentioned above, thus, for processes, in the case of which the process medium has a high temperature (≤ 400° C.) and simultaneously low process pressures (<1 bar).

### LIST OF REFERENCE CHARACTERS

1 sensor module
2 transfer module
11 sensor body
12 measuring cell duct
13 first end face
15 measuring cell chamber
16 pressure measuring cell
17 assembly wall
18 first assembly end face
21 process body
22 transfer body
23 traversing capillary duct
24 process diaphragm
25 transfer diaphragm
26 second assembly end face
28 transfer pressure chamber
29 process pressure chamber

1-5. (canceled)

6. A method of using a
gallium-based alloy, includes:
using a gallium-based alloy as pressure transfer liquid in a hydraulic pressure transfer means for determining a process pressure in a process, in which the process medium has a process temperature ≤400° C. and a process pressure <1 bar absolute, wherein the alloy contains, besides gallium, furthermore, at least one other component and the mixing ratio between gallium and the at least one additional component is selected in such a manner that the alloy has a melting temperature less than 20° C.

7. The method as claimed in claim 6, wherein the alloy has a plurality of other components and the mixing ratios between gallium and the plurality of other components are selected in such a manner that the alloy has a melting temperature less than 20° C.

8. The method as claimed in claim 6, wherein the one or more other components are selected from metal having a melting point less than 450° C.

9. The method as claimed in claim 6, wherein the one or more other components are selected from indium, tin, zinc, lead, bismuth, and/or mercury.

10. The method as claimed in claim 6, wherein the alloy contains at least 50 mass percent gallium.
